(19) United States
(12) Patent Application Publication
(10) Pub. No.: US 2007/0261527 A1
(43) Pub. Date: Nov. 15, 2007

(54) Wood sawing machine

(76) Inventor: Tian Wang Wang, Taichung Hsien (TW)

Correspondence Address: Wang, Tian Wang, P.O. Box 44 - 2049, Taipei, 10668, TW

(21) Appl. No.: 11/432,324

(22) Filed: May 12, 2006

(51) Int. Cl. B23D 45/06

(52) U.S. Cl. 83/477.1; 83/477.2

(57) ABSTRACT

A wood sawing machine includes a motor base, a transmission motor and a sawing device that are integrated together and disposed on the motor base, a transmission gear set and a screw rod connected to the gear set. The rotated screw rod moves a collet in a sliding sleeve such that the sawing blade assembly can be moved vertically. Thus, the machine has a simple structure and the sawing blade assembly can be lifted and lowered quickly. Due to the vertical movement, the size of the sawing machine can be reduced, and the manufacturing cost thereof can be decreased.

### BACKGROUND OF THE INVENTION

(1) Field of the Invention

The invention relates to a wood sawing machine mainly including a motor base, a transmission motor and a sawing device that are integrated together and disposed on the motor base, and a transmission gear set, which is driven such that a sawing blade assembly is moved vertically. Thus, the machine can be operated easily and has a simple structure, and the sawing blade assembly can be lifted and lowered quickly.

(2) Description of the Prior Art

FIG. 1 is a schematic illustration showing a structure of a wood sawing device having a sawing blade assembly that can be moved up and down. As shown in FIG. 1, a sawing blade (10) is assembled on an adjusting toothed piece (11), a motor (12) is connected to one side of the adjusting toothed piece (11), a pivot (14) pivots the adjusting toothed piece (11) and the motor (12) onto a mounting base (13). A shaft piece (15) disposed at a side of the mounting base (13) is screwed to a screw rod (16). The screw rod (16) is rotated such that the adjusting toothed piece (11) properly swings about the pivot (14) to adjust the level of the sawing blade (10).

However, the lifting and lowering mechanism mainly controls the displacement of the adjusting toothed piece through the screwing of the shaft piece, and a swing up and down operation is generated through the pivot. Thus, the centrifugal motion is caused, the overall assembly structure is complicated, the maintenance of the machine is complicated, and the time of up and down movements is also long. If the up and down movements are to be performed according to the thickness of the wood, a longer period of time has to be spent, and the working efficiency is thus decreased.

Furthermore, the moving distance of the sawing blade is longer during the up and down movements, so the slot pre-formed on the table has to be lengthened such that the overall area of the table has to be enlarged, and the manufacturing cost is thus increased.

### SUMMARY OF THE INVENTION

In order to solve the drawback of the conventional wood sawing machine, it is therefore an object of the invention to provide a wood sawing machine having an integrated sawing device, which can be lifted and lowered simply using a support and a sliding sleeve synchronized therewith.

Another object of the invention is to provide a wood sawing machine having a sawing device, which can be lifted and lower quickly with the enhanced working efficiency. In addition, the area of a table of the sawing machine can be effectively controlled, and the disposed space and the manufacturing cost can be effectively reduced.

Still another object of the invention is to provide a wood sawing machine having a mounting base and a transversal rod for connecting two sides of the mounting base to make the overall architecture stable and enhance the stability of operating the machine.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic illustration showing a structure of a wood sawing device;

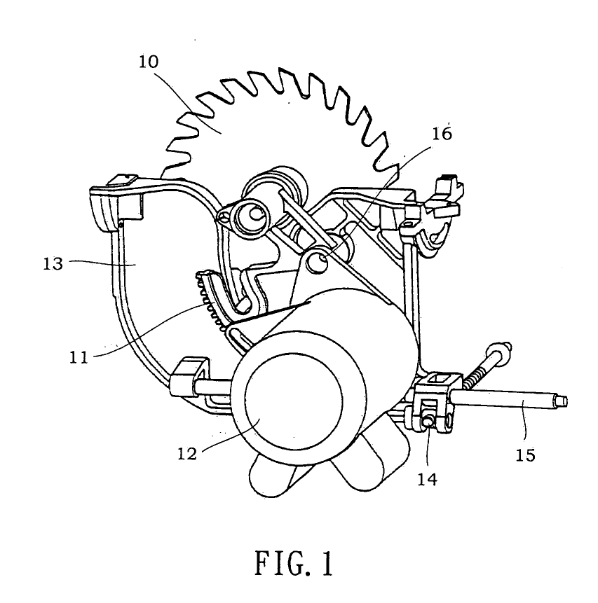

FIG. 2 is a schematic illustration showing a structure of a sawing device of the invention;

FIG. 3 is a schematic illustration showing the structure of the sawing device of the invention;

FIG. 4 is a schematic illustration showing the structure of the sawing device of the invention when a sawing blade is lowered;

FIG. 5 is a schematic illustration showing the structure of the sawing device of the invention when the sawing blade is lifted; and

FIG. 6 is a schematic illustration showing a structure of a wood sawing table of the invention.

### DETAILED DESCRIPTION OF THE PREFERRED EMBODIMENTS

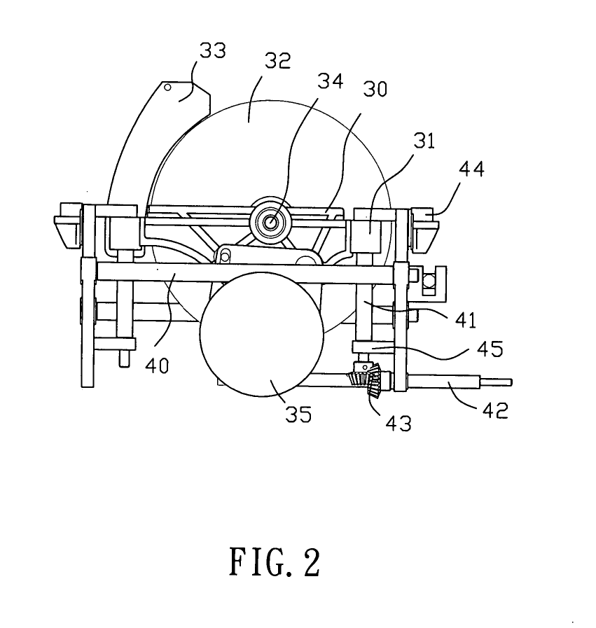

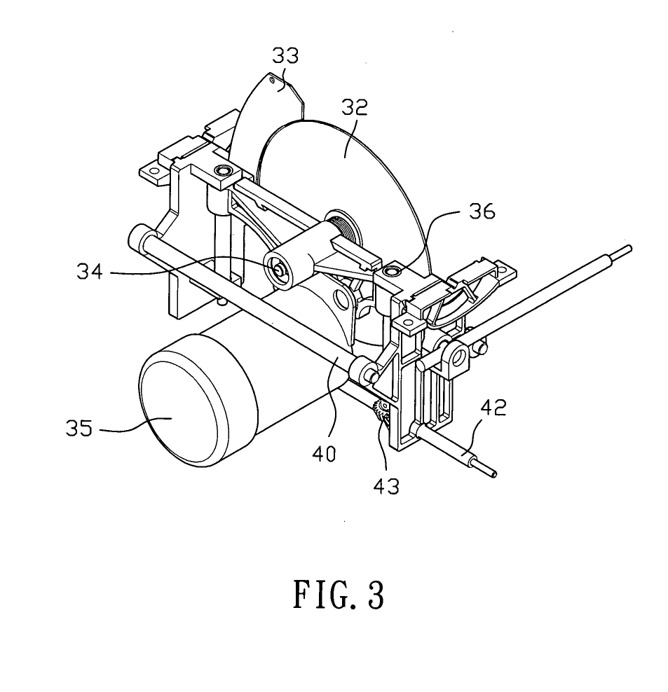

FIGS. 2 and 3 are schematic illustrations showing a structure of a sawing device of the invention. As shown in FIGS. 2 and 3, the structure of the invention mainly has a motor base (30) and two sliding sleeves (31) integrally formed at two sides of the base (30). A collet (36) is disposed in the sliding sleeve (31). A motor (35) is fixed to one side of the motor base (30). A shaft rod (34) penetrates through the motor base (30) and is mounted on a sawing blade (32). When the motor (35) rotates the shaft rod (34), the sawing blade (32) is rotated to achieve the operation of sawing. A cutter (33) for separating the sawed wood is disposed behind the sawing blade (32) and is parallel to the sawing blade (32) to prevent the cutting edge of the wood, which has passed therethrough, from touching the sawing blade (32) due to the shifting error. If the cutting edge touches the blade, a cutting surface defect is generated. Thus, the cutting stability can be enhanced. The above-mentioned elements are disposed on the motor base (30) to form a synchronized sawing device.

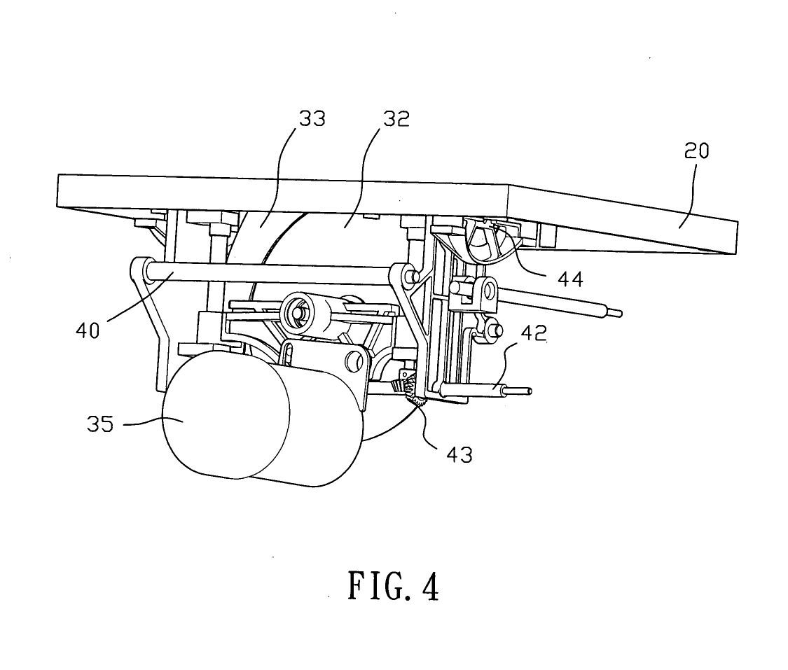

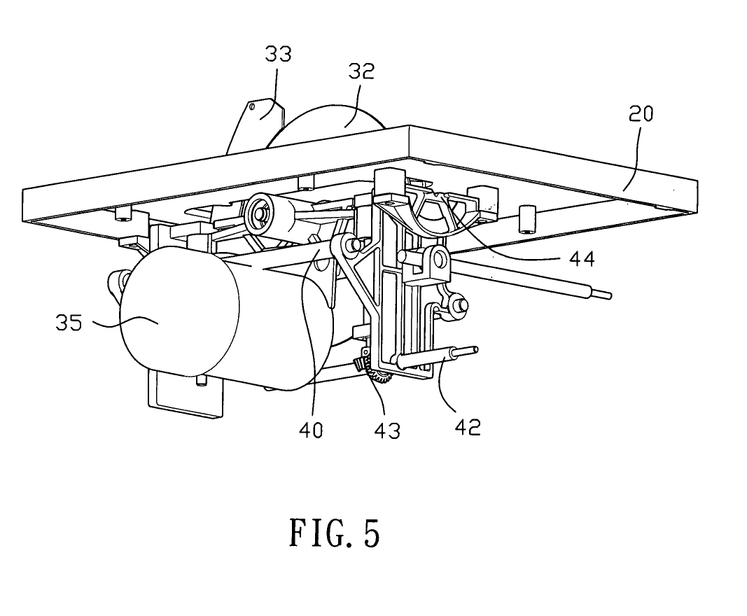

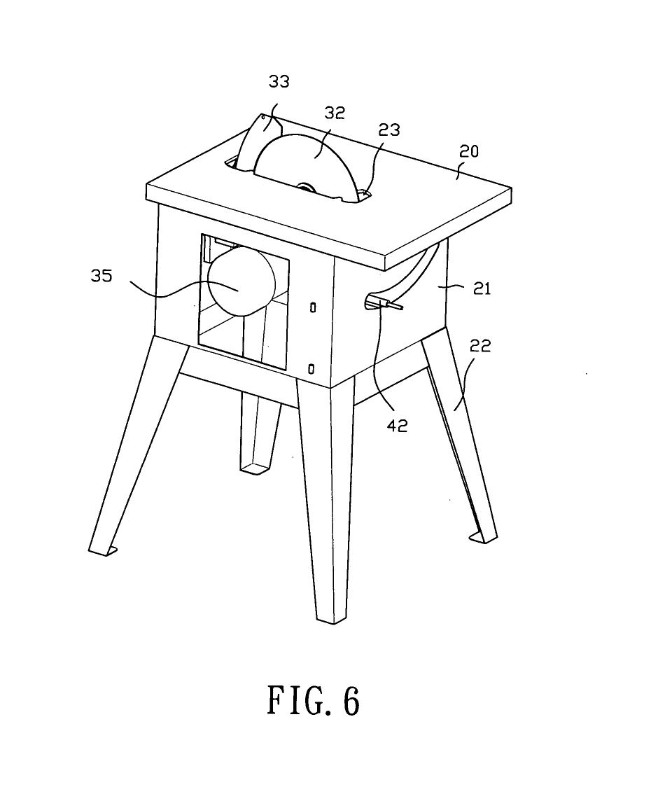

FIG. 4 is a schematic illustration showing the structure of the sawing device of the invention when a sawing blade is lowered. FIG. 5 is a schematic illustration showing the structure of the sawing device of the invention when the sawing blade is lifted. FIG. 6 is a schematic illustration showing a structure of a wood sawing table of the invention. As shown in FIGS. 4 to 6, the periphery of the sawing device is connected to a mounting base (44) through a stopping block (45). The mounting base (44) is composed of symmetrical supports (41) and transversal rods (40). A transmission gear set (43) is disposed at the bottom of the support (41) at the right-hand side. A screw rod extending out of the mounting base (44) is connected to the gear set (43). Thus, the combination of the elements of the invention and the sawing device is completed. In addition, the mounting base is combined with a table (20), a casing (21) and foot stands (22) such that a complete sawing machine is formed.

In addition, the transversal rod (40) connects two sides of the mounting base (44) so as to enhance the stability and secure property of the overall mechanism.

The support (41) is fitted with the sliding sleeve (31). The user may rotate the screw rod (42) such that the transmission gear set (43) in engagement with each other rotates the support (41). It is possible to control the sawing device to move vertically according to the synchronized relationship of the collet (36) in the sliding sleeve (31). Furthermore, the up and down positioning processes of the sawing device are achieved according to the cooperation and restriction of the sliding sleeve (31) and the stopping block (45). Moving the sawing device up and down in a vertical direction can shorten the operation time, the slot (23) of the table (20) through which the sawing blade (32) passes does not have to be formed wider. Thus, the size of the table (20) can be effectively optimized such that the manufacturing cost can be reduced and the trouble of disposing the machine can be reduced.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A wood sawing machine, comprising:
a sawing device, which may be lifted and lowered by rotating a screw rod to drive a transmission gear set and comprises:
a motor base;
two sliding sleeves disposed at two sides of the motor base;
a shaft rod penetrating through the motor base;
a sawing blade mounted on the shaft rod;
a motor for rotating the sawing blade to saw wood; and
a cutter, which is disposed behind the sawing blade and in parallel to the sawing blade, for separating the sawed wood passing therethrough; and
a mounting base connected to the sawing device through stopping blocks, wherein the mounting base has symmetrical supports at two sides, a transversal rod is connected to the two sides of the mounting base, the transmission gear set is disposed on a bottom of one of the supports, the screw rod connected to the gear set extends out of the mounting base, and the screw rod can be operated to move the sawing device up and down.

2. The wood sawing machine according to claim 1, wherein the sawing device is moved up and down through a collet in the sliding sleeve when the support is rotated by the transmission gear set, which is rotated by the screw rod, and the stopping blocks restrict up and down positioning processes of the sliding sleeves.

3. The wood sawing machine according to claim 1, wherein the transversal rod is connected to the two sides of the mounting base to make the mounting base stable.
